(19) United States
(12) Patent Application Publication
(10) Pub. No.: US 2004/0049445 A1
(43) Pub. Date: Mar. 11, 2004

(54) Financial services automation

(76) Inventor: Nanda Kishore, Los Altos, CA (US)

Correspondence Address: Daniel M DeVos, Blakely Sokoloff Taylor & Zafman LLP, 12400 Wilshire Boulevard Seventh Floor, Los Angeles, CA, 90025, US

(21) Appl. No.: 10/241,218

(22) Filed: Sep. 10, 2002

(51) Int. Cl. G06F 17/60

(52) U.S. Cl. 705/37

(57) ABSTRACT

A system and method are provided for delivering financial services in a substantially automated and efficient manner. In one embodiment, an integrated Internet-based common digital platform automates and simplifies a mortgage closing process by receiving transaction information and merging the same with a set of electronic documents. The common digital platform then selectively permits users to access and edit certain ones of the documents, permits electronic signature of the documents, records transfers of negotiable instruments associated with the transaction, and stores the electronic documents in an electronic vault. The common digital platform also includes a dynamic pricing engine containing updated cost estimates for various closing cost elements in multiple geographical regions and generates closing cost estimates based on the geographical location of the real estate.

### CROSS-REFERENCE TO RELATED APPLICATIONS

This application relates to U.S. patent application Ser. No. 09/706,453, filed Nov. 3, 2000, which is a continuation-in-part of U.S. patent application Ser. No. 09/510,655, filed Feb. 22, 2000, the disclosures of both are incorporated herein by reference in their respective entireties.

### TECHNICAL FIELD

The present system and method relate to financial services automation.

### BACKGROUND

The number of participants involved in a financial transaction and the number of documents generated as part of the transaction complicate many types of financial transactions. Example types of transactions include loans, insurance, and mortgages. It is common in such financial transactions for various participants, such as lenders, agents, customers, investors, and the like, to generate, review, modify, approve, or sign certain documents as the transaction progresses to completion.

Due, at least in part, to the number of participants in a transaction and the numerous documents involved, visibility into the entire transaction by any one participant at any point along the progress of the transaction is typically limited. For example, it is conventionally difficult for the transaction participants to view the status, or contents, of the various transaction documents on demand. Indeed, each document is typically in the possession of only one of the participants at any given time and, consequently, cannot be readily viewed by each of the other participants.

Additionally, since different participants generate different documents, there may be inconsistencies between the various transaction documents, as well as other types of errors. In some instances, these errors are not discovered until after the transaction is complete, thus resulting in error-laden transaction documents. In other instances, one or more of the transaction participants detects these errors and causes the errors to be corrected. This detection and correction of the various errors in the transaction documents is typically time consuming, creates delay in completing the transaction, and generally increases the costs and time needed to complete the transaction. Indeed, it is common for the various participants to manually review and check figures and other text in their own and in each other's documents. This review process may be inefficient, time-consuming, cumbersome, and usually adds time and expense to the completion of the transaction.

Further, in some financial transactions, such as mortgages, it is common for the lender to provide the borrower with an estimate of the closing costs associated with closing the mortgage loan. These closing costs typically include the lender's fees as well as fees by the closing services provider. These estimates are frequently highly inaccurate, which may require borrower payment of closing costs that are significantly greater than those estimated. Being required to pay closing costs significantly greater than those of the original estimate may cause some borrowers to not close the transaction, thus causing the transaction to fail.

After a mortgage transaction closes, it is common for ownership of the loan (i.e., ownership of the negotiable instrument associated with the loan) to change. Indeed, some lenders sell such loans to investors, who may later sell the loans to other investors. Due to the large number of such loans typically transferred between different entities, organizing, transferring, and storing such negotiable instruments can be burdensome and expensive.

### SUMMARY

A need exists, therefore, for a system and method for providing financial services that provides improved transaction visibility, provides estimates with greater accuracy, improve efficiency, reduces errors or inconsistencies in the transaction documents, and permits the provision of financial services in a more efficient manner.

According to one aspect of the present invention, a system and method are provided for facilitating a financial transaction by providing a common digital platform accessible to a plurality of users. The common digital platform includes a set of electronic documents with each electronic document having a data index and a set of data fields associated with the document. The digital platform receives transaction information and merges the received transaction information in the data index associated with each document. The data fields of the document are then populated with the information from the data index of each document. It is then determined whether corresponding data fields in different documents contain identical information, whether corresponding data fields in a single document contain identical information, and whether the information in the data fields of the various documents is identical with corresponding data of the received transaction information. Inconsistent or otherwise erroneous information may be thus identified and can be readily corrected.

According to another aspect of the present invention, a system and method are provided for determining an estimate of closing costs associated with a real estate transaction. A database is provided that includes a cost estimate for each of a plurality of separate costs for each of a plurality of geographical locations. A set of separate costs is identified from the database using transaction information, including information regarding geographical location of the real estate. An estimate of closing costs is then determined based on the set of separate costs identified from the database. The separate costs of the database may be frequently updated to improve estimate accuracy. In one embodiment, updated cost information is electronically received at the common digital platform via the Internet.

In another embodiment of the present invention, a system and method are provided for automating a real estate mortgage transaction by generating a set of real estate mortgage transaction documents, the real estate mortgage transaction documents including a note. The note, and perhaps other of the real estate mortgage transaction documents, are then electronically executed by the borrower. After execution of the note, the executed note is tamper sealed, such as by encryption. The tamper-sealed note is then stored in an electronic vault.

In addition, a record of transfer may be associated with the tamper sealed note to maintain an ownership record of the associated note. In one embodiment, lender information is listed as an entry on the record of transfer. Then, after receiving information identifying a transfer to a first investor, first investor information is listed as an entry on the record of transfer. In this manner, the present system and method may efficiently permit transfers of notes, including large quantities of notes, between lenders and investors, between investors, or both.

These and other features will be apparent from the following description and associated drawings.

### BRIEF DESCRIPTION OF THE DRAWINGS

FIG. 1 illustrates an example network in which embodiments of the present system and method may be practiced.

FIG. 2 illustrates details of an example embodiment of an automated financial services engine.

FIG. 3 is a workflow diagram in accordance with an example embodiment of the present invention.

FIG. 4 illustrates a process diagram in accordance with an example embodiment of the present invention.

FIG. 5 illustrates one example implementation of a software system.

### DETAILED DESCRIPTION

Environment

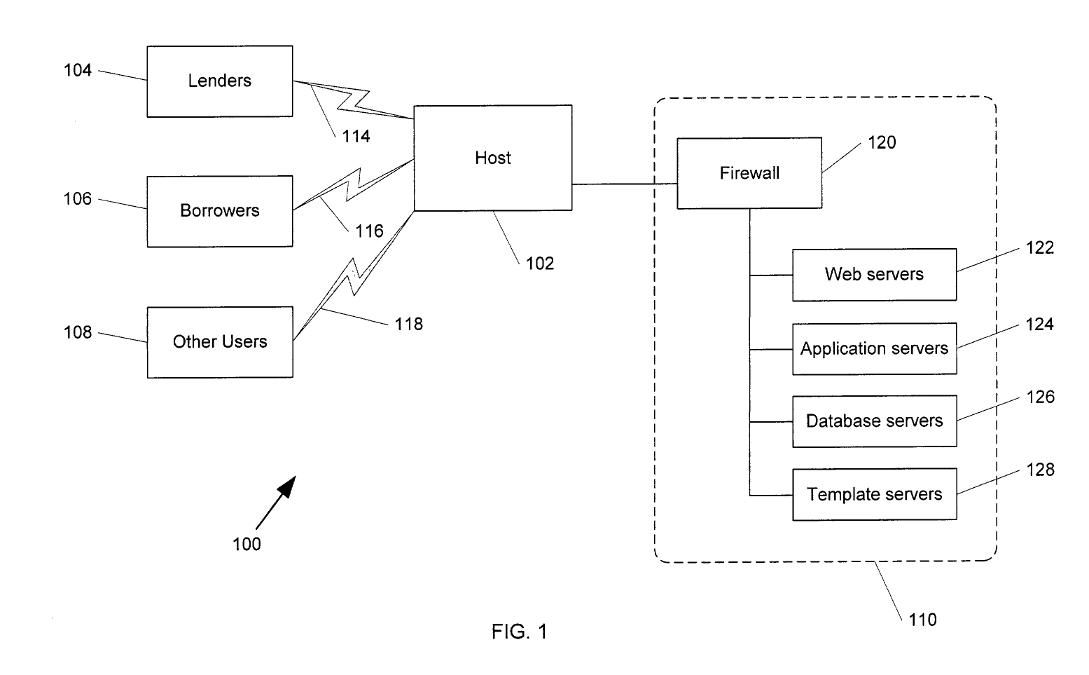

FIG. 1 illustrates an example environment in which embodiments of the invention may be practiced. In general, FIG. 1 illustrates a network 100 including a host 102, lenders 104, borrowers 106, other users 108, and a financial services system 110. The lenders 104, borrowers, and other users 108 access the host 120 through communication links 114, 116, and 118, respectively. The links 114, 116, 118 may comprise any of a wide variety of network connections, including connection via the Internet. The lenders 104, borrowers 106, and other users 108 may exchange data with the financial services system 110 using, for example, a personal computer having a web browser, such as Internet Explorer™ or Netscape Navigator™, or other suitable browser or interface. The lenders 104, borrowers 106, and other users 108 may interface with the financial services system 110 via the web browser application. Typically, user access to the financial services system 110 will be at least password-protected.

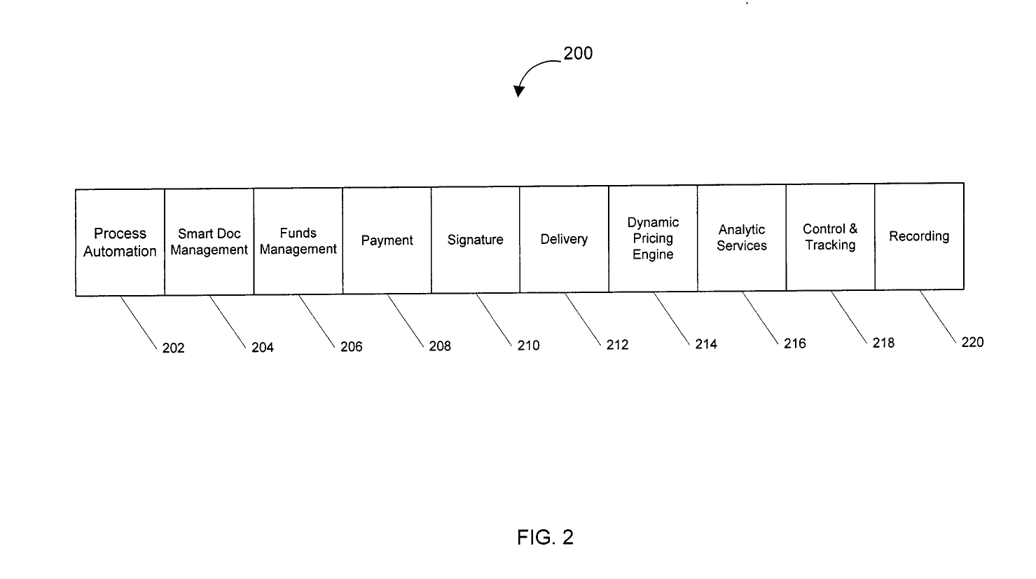

The host 102 connects to web servers 122, application servers 124, database servers 126, and template servers 128 via a firewall 120. The web servers 122 may comprise a single web server or a cluster of web servers configured to serve documents to one or more of the lenders 106, borrowers 106, and other users 108. The application servers 124 may comprise a single application server or a cluster of application servers configured to run a financial services engine (see, e.g., FIG. 2), perform load balancing tasks, and the like. The database servers 126 may include a single database server or a set of database servers arranged in a master/slave configuration. The database servers 126 store transaction information and other information as discussed in more detail below. The template servers 128 may comprise one or more file servers that store document templates. In one embodiment, the template servers 128 run Network File System (NFS) to permit access to the document templates.

Pursuant to this configuration, lenders 104, borrowers 106, and other users 108 may remotely access the financial services system 110 to remotely conduct financial transactions in an electronic, and substantially automated, manner. One example application of the financial services system 110 relates to the home mortgage loan process. The financial services engine 110 may also provide a wide range of other financial services.

Financial Services Engine

FIG. 2 illustrates details of one embodiment of an automated financial services engine 200, which may run on one or more of the application servers 124 (FIG. 1). In one embodiment, the financial services engine 200 comprises software running on one or more of the application servers 124 (FIG. 1). The engine 200 is shown as including modules 202-220. The details of which are described below.

Process automation module 202 serves as workflow engine and generally coordinates the functions of the modules 204-220. Because a given financial transaction may include multiple participants (e.g., a lender, a closing agent, a borrower, etc.), the process automation module 202 permits the various participants to work in a collaborative fashion in the processing of the transaction. The process automation module 202 generates a workflow for a given transaction. The generated workflow may then be customized such that the different participants involved in the transaction may have different, customized workflows. Moreover, different customers may have different customized workflows for similar transactions, according to individual customer preferences. In operation, the process automation module 202 instantiates an instance of a workflow for a particular transaction and manages the workflow for the use of the multiple participants.

Financial transactions typically involve some form of documentation. Smart document management module 204 generally manages such documentation.

Commonly, the various transaction participants prepare transaction documentation on paper. For example, in a typical home mortgage loan transaction, one participant may prepare investor documents (i.e., negotiable instruments, such as the note), another participant may prepare disclosure documents, and yet another participant may prepare loan specific documents (i.e., loan application). These documents frequently recite information of the same type, such as the name of the borrower and the address of the real estate being purchased. However, these documents frequently lack “semantic integrity,” meaning that the documents lack consistent information throughout. For example, in one document, the borrower's name might be listed as “John Q. Doe.” In another document, the borrower's name might be listed as “John H. Doe.” In yet another document the borrower's name might be listed as “John Henry Doe”, thereby creating inconsistency between the documents. Inconsistencies such as these reduce the semantic integrity of the documentation and may create ambiguity.

Further, the information in the documentation may be wrong due to typographical errors. For example, the interest rate of a loan in one document may be listed as “800” rather than as “0.08” due to a typographical error.

The smart document management module 204 addresses one or more of these issues by using a set of “smart documents.” The smart documents comprise electronic documents that provide a consistent manner in which data within the documents is indexed. Although the format of the smart documents may vary, in some embodiments, the smart documents may comprise HTML documents, XML documents, or XHTML documents. Details regarding some embodiments of smart documents are disclosed in “Mortgage Industry Standards Maintenance Organization eMortgage Workgroup/SMART Document Focus Group, SMART Document Specification” by Mike Daconta and Rachael Sokolowski, version 1.0 DRAFT, Release Candidate 4.1, released Feb. 5, 2002 and in “An Overview of SMART Documents,” Property Records Industry Joint Task Force, 2002 Legislative Conference, Washington D.C. by Fannie Mae, the disclosures of which are incorporated herein by reference in their respective entireties.

The integrity of the set of documents associated with a given transaction may be verified to ensure that the information within the documents is consistent. Additionally, as the information changes, or is updated, the information may be changed in a uniform manner across all of the documents.

Further, the smart document management module 204 may include rule engines to ensure that the entered information conforms to certain predetermined requirements. For example, the rule engines may require that interest rate of a loan be between 1-20% or some other predetermined range or set of values. In this manner, the rule engines may identify some typographical errors and prevent such errors from entering the smart document management module.

In one embodiment, the smart document management module 204 instantiates a set of documents for a new transaction and receives preliminary information associated with this set of documents. Subject to predetermined access rules, the participants associated with the transaction may modify and update the information. After all of the necessary information is entered into the smart document management module 204, the smart document management module 204 analyzes the set of documents to identify inconsistencies in the data in any given document, between documents, and between the documents and transaction information. The identified inconsistencies may then be corrected before document finalization. As discussed in more detail below, the finalized documents may then be electronically signed, tamper sealed, delivered, analyzed, tracked, and recorded. The semantic integrity of the set of documents may alternatively or additionally be confirmed after the documents have been signed to permit verification that the information within the documents is consistent. In addition, the document integrity may also be verified by validating the tamper-seal. Details regarding the tamper seal are discussed below.

Funds management module 206 generally manages the transfer of monetary funds between parties associated with the transaction. In financial transactions, the parties typically transfer monetary funds. It is desirable in these transactions that the amount of funds flowing into the transaction equal the funds flowing out of the transaction. That is, amounts paid should equal amounts received.

In some transactions, such as home mortgage transaction, several participants receive funds from the transaction. These participants may include, for example, a property appraiser, a title company, a lender, a closing agent, and the like. Before the transaction documents are finalized, it is desirable that the sum paid by the borrower equal the total amount to be paid to the various participants.

The funds management module 206 monitors the balance of funds to be paid by the borrower and those to be paid to the various participants to ensure that the inflow of funds paid by the borrower and the outflow of funds paid to the various participants equal one another. After the funds management module 206 determines that the inflow of funds equals the outflow of funds, the funds management module 206 permits the transaction documents to be finalized and signed. The funds management module 206 may prevent the transaction from being finalized or signed until the funds management module determines that the inflow of funds equals the outflow of funds.

Payment module 208 performs a derivative task of executing the transfer of funds after the funds management module 206 has determined that the fund inflows equal the fund outflows and after the fund inflows are received. Fund inflows typically come by a check or by a wire transfer. The amount of the fund inflows may be confirmed by a user upon receipt of the fund inflows. Indeed, the funds management module 206 may cause an electronic, or other, message to be transmitted to one or more predetermined users upon receipt of the fund inflows. The payment module 208 may then execute payment of the fund outflows. For example, the payment module 208 may print out checks, send a fund wire transfer, or an ACH (Associated Clearing House) disbursement to the payees.

In one embodiment, the payment module 208 also performs an auto-reconciliation function whereby the payment module 208 at least partially reconciles or supports reconciliation of funds cleared with a bank or other financial institution. Pursuant to one embodiment, the payment module 208 received fund clearance data from a bank or other financial institution, such as over the link 118 (FIG. 1) and reconciles the received fund clearance data with internal disbursement data to identify disbursements that have cleared and that have not cleared. The payment module 208, in performing the auto-reconciliation function may also identify, such as by flagging, certain disbursements for which auto-reconciliation may not be performed. The payment module 208, in this manner, substantially automates and facilitates the reconciliation process.

Signature module 210 permits electronic execution of the finalized documents. In the context of a home mortgage transaction, the documents to be signed typically include disclosure documents, investor documents, and loan specific documents. In the past, such documents have been generated in paper form and are signed by the borrower physically writing their name in ink on the paper documents. The signature module 210, however, permits a party, such as a borrower, to execute the documents electronically.

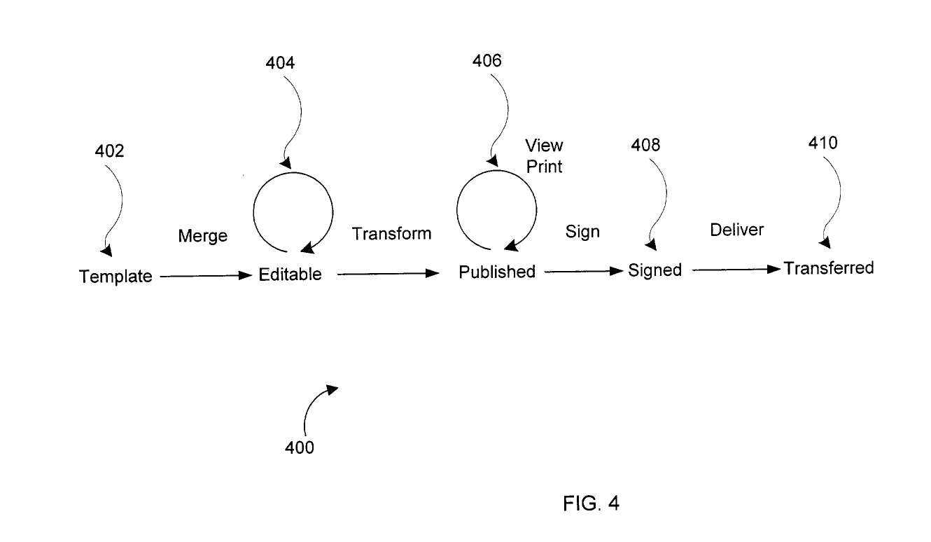

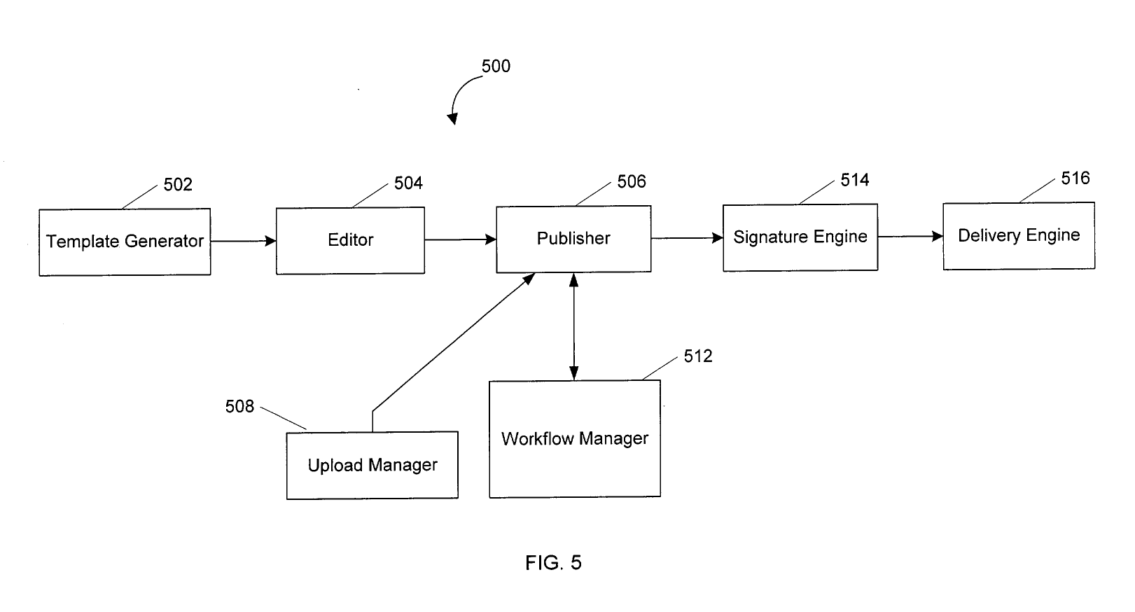

The signature module 210 permits electronic execution of the finalized documents by a variety of mechanisms, including, for example, click signing, holograph signing, password-based systems, and the like. It is desirable that the electronic signing mechanism be such that the document execution be legally recognized and enforceable. Additional details regarding application of electronic signatures are described below with reference to FIGS. 4 and 5.

Delivery module 212 facilitates electronically changing ownership of negotiable instruments associated with the financial transaction. For example, in a home mortgage transaction, a note may comprise the negotiable instrument associated with the financial transaction. The delivery module 212 permits ownership of the note to be changed from the initial lender to an investor in an efficient manner by flipping ownership and maintaining a record of transfer (ROT) of the ownership of the note. This permits the initial lender to sell the note to an investor in a timely and efficient manner. Further, the delivery module 212 permits and facilitates subsequent transfers of the note, or a set of notes, between investors. In one embodiment, and as discussed below, to ensure the security of such transfers public key encryption technology or other suitable encryption technology may be employed.

Dynamic pricing engine 214 is used to generate estimated costs associated with the transaction. In the context of a home mortgage transaction, these costs typically include lender loan fees and closing service provider fees and are frequently referred to as “closing costs.” The estimate of these closing costs is commonly referred to as a Good Faith Estimate (GFE). For a home mortgage transaction, these closing costs may include, for example, real estate agent commissions, points, processing fees, taxes, appraiser fees, inspection fees, and the like.

Conventionally, these closing costs have been difficult to consistently estimate with a high degree of accuracy. This difficulty tends to arise, at least in part, in attempting to estimate the closing service provider fees. These fees change frequently and vary depending on the location of the real estate being purchased. In the past, closing cost estimates have typically been highly inaccurate. In some circumstances, these estimates may be off by 30% or more in over half of all GFEs.

The dynamic pricing engine 214 includes a database that contains data necessary for accurately estimating the closing costs for many different geographical areas. This database is frequently updated in electronic fashion so that as various costs and fees change in the various geographical areas, the database is updated to reflect these changes.

In operation, a user enters transaction information, including an address of the real estate being purchased into the dynamic pricing engine 214, along with other known information as may be obtained from a typical loan application. Based on the entered transaction information and the database contents, the dynamic pricing engine 214 calculates the estimated closing costs automatically. In one embodiment, the dynamic pricing engine looks up a set of separate costs associated with the geographical location of the real estate and sums these costs to provide at least a component of the closing cost estimate. In some applications, calculating the closing cost estimate automatically and using the updated information of the database provides accurate good faith estimates that typically differ from the actual costs by no more than about 2%.

Providing an accurate good faith estimate of closing costs reduces borrower surprise at closing since the estimated closing costs will typically be within about 2% of the estimated closing costs. This may provide a more satisfying experience for the borrower and may reduce the number of loan transactions that fail due to borrower unwillingness to pay closing costs that substantially exceed the closing costs estimated in the GFE.

Analytic services module 216 permits analytic services to be performed on loan data for generating business intelligence. Using the analytic services module 216, a lender, or other user, may analyze data and generate statistics associated with a user's transactions. For example, the analytic services module 216 may analyze their data to calculate data such as the number of loans closed in a certain time frame, the average time taken to close a set of loans, the number or percentage of loans that were commenced and not closed and the like.

In addition, the analytic services module 216 may also provide market information to a particular lender regarding the characteristics of the data. For example, a lender may be able to determine what percentage of the total loans for a particular geographical area were closed by the lender and what percentages were closed by the various competitors. This may require, however, that the identities of the various competitors not be disclosed. Thus, aggregate data and the analysis of the same is performed by the analytic services module 216.

Control and tracking module 218 controls advancement of a transaction through the process. The tracking aspect of the control and tracking module 218 tracks the progress of the transaction through the process. The control and tracking module 218 tracks when certain milestones are accomplished or passed. Each party to the transaction may have access to different tracking information. Further, the control and tracking module 218 may notify, such as by email, different users when certain transaction milestones are accomplished or passed. Users may also view this information remotely via the network 100 (FIG. 1).

The recording module 220, permits electronic recordation of the transaction documents with a recorder, such as a county or state recorder. The recording module 220 may electronically exchange transaction recordation document with a recorder over the Internet and via the host 102 (FIG. 1). Conventionally, the recording process is performed manually. Additional details regarding electronic recordation are discussed below with reference to FIGS. 4 and 5.

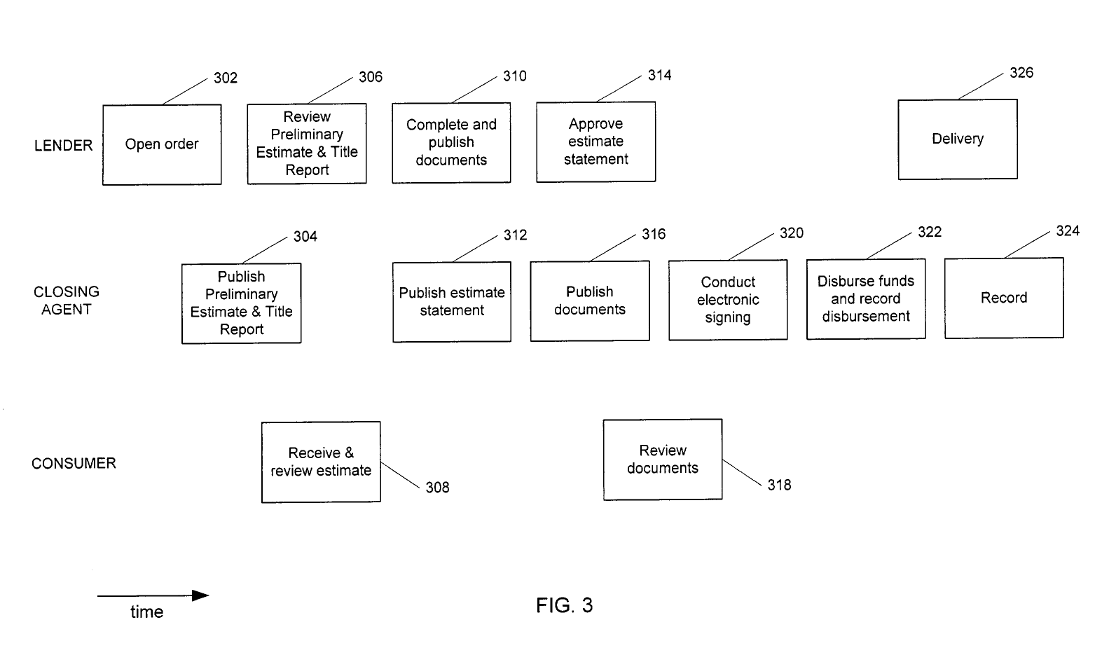

FIG. 3 is a workflow diagram 300 in accordance with one embodiment of the present invention and illustrates various actions by the lender, agent, and consumer with respect to time. As illustrated, the workflow begins at block 302 with the lender opening an order. At block 302, the lender transmits loan application information (sometimes referred to as 1003 data) to the engine 200 (FIG. 2). By electronically transmitting the loan application information, such as over the network 100 (FIG. 1), the need to manually enter the loan information into the engine 200 is eliminated, thereby saving time and potentially reducing data entry errors. After the engine 200 receives the loan application information, the lender may optionally electronically transmit data to the engine 200 identifying a closing agent associated with the transaction and whether the documents associated with the transaction will be signed electronically or otherwise.

Next, at block 304, the closing agent completes opening the order and publishes an estimate of closing costs associated with the transaction and a preliminary title report. This estimate of closing costs may be referred to as a “good faith estimate” or a “HUD 1A” and the preliminary title report may be referred to as a “commitment to insure.” At block 304, the engine 200 (FIG. 2) may also transmit a message, such as an email message, to the closing agent identified in block 302, to inform the identified closing agent of the new order. Upon receiving the transmitted message, the closing agent may access and edit the estimate of closing costs as generated by the engine 200 to complete preparation of the estimate of closing costs. In one embodiment the agent uses the dynamic pricing engine 214 (FIG. 2) in determining the estimate of closing costs. The closing agent may then transmit the completed estimate of closing costs to the lender via electronic or other means. In one embodiment, the closing agent transmits the completed estimate of closing costs to the lender via email.

At block 304, the closing agent also prepares the preliminary title report by accessing and selecting an appropriate preliminary title report form from the smart documents of the engine 200 (FIG. 2). The selected smart document is then added to the transaction documents. The engine 200 then automatically populates the selected smart document with the known data relevant to the form and permits the closing agent to complete the form by entering data necessary to complete the form. After the closing agent has completed preparation of the preliminary title report form, the closing agent transmits a message to the engine 200 indicating that the preliminary title report is completed and may be published. In one embodiment, the closing agent may specify a limited set of users to whom the preliminary title report is published. Thus, the specified users, such as the borrower and the lender may view the completed preliminary title report by accessing the associated smart document on the engine 200.

At block 306, the lender reviews the estimate of closing costs associated with the transaction in the preliminary title report. The lender may access the engine 200 electronically and, after entry of a password or other login process, views a list of active orders for the lender. The lender may then select a particular order and, in response, the engine 200 permits the lender to view the published documents associated with the selected order. For example, early in the transaction, the closing agent may publish the estimate of closing costs and the preliminary title report and specify the lender as a user to whom these documents may be published.

At block 308 the customer, or borrower, may also view the estimate of closing costs associated with the transaction in the preliminary title report. Like the lender, the customer may remotely access and log into the engine 200 via the network 100 (FIG. 1) and may view the published documents associated with the customer's transaction. In one embodiment, the engine 200 sends the customer and email message informing the customer of the password or other login information to be used by the customer in logging into the engine 200.

At block 310, the lender completes document preparation and publishes the documents using the engine 200 (FIG. 2). In one embodiment, the lender logs on to the engine 200 and selects a note that may be electronically signed by the customer. The engine 200 completes known data fields and permits the lender to complete and edit the note. The engine 200 also permits the lender to upload documents, such as .pdf (Portable Document Format) files or files in other suitable formats, to be included in the transaction.

At block 312, the closing agent enters additional data to the statement of estimated closing costs to generate a completed statement of closing costs, also referred to as a final HUD 1A document. In particular, the closing agent logs into the engine 200 and views the estimated HUD 1A. Then, the engine 200 presents the closing agent with a series of pop-up windows to facilitate entry of the necessary information to finalize the final HUD 1A document. The engine 200 then permits the closing agent to publish the final HUD 1A document by selecting a set of users (e.g., the customer and the lender) that may log onto the engine 200 and view the final HUD 1A document.

At block 314, the lender approves the final HUD 1A document. In one embodiment, the lender logs onto the engine 200 and specifies a particular one of the orders associated with the lender. The engine 200 then permits the lender to view the published final HUD 1A. The engine 200 may maintain a status of the final HUD 1A to indicate whether the lender has reviewed final HUD 1A and whether the lender has accepted the final HUD 1A. After the lender has reviewed the final HUD 1A, the lender can change the status of the final HUD 1A to indicate that the lender has reviewed the final HUD 1A and whether the lender has approved the final HUD 1A.

At block 316, the closing agent completes document preparation and publishes the documents. The closing agent may add a document to the transaction by (1) selecting one of a predetermined set of smart documents stored at the engine 200, (2) uploading a file comprising the document to be added, or (3) transmitting via facsimile the document to be added to a facsimile number associated with the engine 200 and then logging on to the engine 200 to assign the document to a particular transaction. After adding a completed document to the transaction, the closing agent may publish the added document by specifying a set of users by whom the document may be viewed.

At block 318, the customer, or borrower, reviews all of the completed documents by logging onto the engine 200 and reviewing the published documents. The customer may change the status of each document to indicate that the customer has reviewed the document and whether the customer has approved the document. The lender and the closing agent may also access the engine 200 to identify documents reviewed, but not approved, by the customer so the lender, closing agent, or both may contact the customer to address any concerns.

At block 320, the customer electronically signs all documents requiring customer signature. In preparation for the electronic signing of the documents, the closing agent may access the engine 200 and flag or otherwise identify the specific transaction documents that require the signature of the customer. The engine 200 then creates a signing packet or a subset of the transaction documents that includes the specific set of the documents to be signed by the customer. The closing agent may then meet with the consumer to conduct the electronic signing of the documents. Pursuant to one embodiment, the engine 200 associates a digital or electronic signature of the consumer with each signed document. After the documents requiring signature have been electronically signed, the engine 200 stores the electronic original of each electronically signed document to a secure electronic vault for storage. Additional details regarding electronic signing of the transaction documents are described below.

At block 322, the funds are disbursed. In one embodiment, the closing agent uses the final HUD 1A statement to prepare the disbursements. The closing agent receives in all fund inflows and views a balance sheet to ensure that the deposits and deductions are correct, makes any changes needed, verifies that there are sufficient funds to disburse, completes any required wire transfer, check printing, or ACH payment information and marks the order as ready for payment. A disburser then logs onto the engine 200 and reviews the disbursements, and approves or rejects each payment. The disburser then disburses the funds via wire transfer from the engine 200, via ACH payment from the engine, by printing checks from the engine 200, or other means.

At block 324, after the funds have been disbursed, the engine 200 (FIG. 2) transmits certain documents associated with the transaction to a previously identified recording agency. The recording agency may be a government recording entity, such as the county recorder for the county in which the real estate purchased is located.

At block 326, the lender uses the engine 200 to electronically deliver the signed transaction documents to an investor. The lender logs onto the engine 200, selects a given transaction, and submits a message indicating that the documents of the selected transaction are to be delivered to a particular investor. The lender then enters information relating to the delivery of the documents to the investor and uses a digital signature to sign a delivery package comprising the documents to be delivered. The engine 200 may then transmit a message, such as an email message, to confirm delivery of the signed transaction documents. The engine 200 also changes ownership of the note, or other negotiable instrument, in the electronic vault to the new investor to whom the signed transaction documents were delivered. Block 326 may be employed each time ownership of the note is to change to maintain a record of all such ownership changes.

FIG. 4 illustrates an example workflow 400 in accordance with some embodiments of the present invention. FIG. 5 illustrates one example implementation of a software system 500, which may run on the application servers 124 (FIG. 1) for performing the workflow 400. As shown, the system 500 includes the following objects, a template generator 502, an editor 504, a publisher 506, an upload manager 508, a workflow manager 512, a signature engine 514, and a delivery engine 516. Details of the workflow 400 and system 500 are discussed below.

The workflow 400 generally illustrates states of the transaction documentation. In particular, the workflow 400 illustrates the following document states, template state 402, editable state 404, published state 406, signed state 408, and transferred state 410.

As shown, initially, a template generator 502 (FIG. 5) generates a dynamic template from a template library (not shown). In one embodiment, the template library comprises a set of smart document templates stored on the template servers 128 (FIG. 1). The template generator 502 generally provides a list of available templates and accesses master templates for each from the template library. The template generator 502 includes and enforces certain high level rules concerning which documents may be or must be included in a particular transaction. For example, for a home mortgage transaction, the template generator 502 may require a certain set of necessary documents for the transaction and may list a certain set of optional documents for the transaction.

A master template for each of the documents may comprise a smart document in a format such as HTML, XML, XHTML, or other suitable format. Each master template may include a header portion that contains information about the document. The header information may include information regarding the type of document (i.e., note, deed, etc.). Each master template may also include a data portion that includes a data index for transaction information supplied and mapping locations associated with individual elements of data in the data index. A static portion of each master template is provided with text, such as boilerplate text, and mapping locations for mapping data elements from the data portion into certain locations of the static portion. It is the static portion of the document that is typically viewed by users. At this point, the documents are in the template state 402.

Next, the editor 504 merges transaction information with each of the templates generated by the template generator 502 for the transaction. In particular, the editor 504 may populate the data or index portion of each of the documents in the transaction with transaction information and generates an editable document that may then be edited by certain predetermined users, such as the transaction participants. The editor 504 may permit some users to access some documents and not others. Similarly, the editor 504 may permit some users to access some documents while not permitting other users to access the documents.

After the editor 504 has merged the transaction information with each of the templates generated by the template generator 502, the documents enter the editable state 404 and may be edited by one or more users according to the editing authorizations of each user. During the editable state 404, the authorized users edit, to the extent desired, the documents to which they respectively have editing access.

Once edited, the edited document passes to the publisher 506, which performs a transform on the editable document to transform the editable document into a published document. The publisher 506 may also receive additional documents, such as documents transmitted by facsimile (“faxed documents”) or portable document format (.pdf) documents from the upload manager 508.

The upload manager 508 receives faxed documents and transforms the faxed documents into the same document format as the editable documents and passes the converted document to the publisher 506. As discussed above, this format may comprise HTML, XML, a combination of HTML and XML, or other suitable format. In addition, the upload manager 508 may receive uploaded documents in electronic formats such as Word™, .pdf, Printer Control Language (PCL), Tagged Image File Format (TIFF), XML, or other suitable format. The upload manager 508 converts the uploaded documents into the same document format as the editable documents and passes the converted document to the publisher 506.

The publisher 506 then validates the editable documents and the uploaded documents by confirming that the transaction information within each document is consistent within the document to confirm that the individual data elements within each document are internally consistent. That is, the publisher 506 determines which data elements used in a single document are used identically throughout the document. The publisher 506 also validates the editable documents and the uploaded documents by confirming the data elements within each of the documents is consistent with the data of the loan application information (sometimes referred to as 1003 data). The publisher 506 also validates the editable documents and uploaded documents by confirming that the data elements in each of the documents are consistent with the same data elements in each of the other documents. If the publisher 506 determines one or more inconsistencies within one or more documents, the publisher 506 identifies the documents containing the inconsistent information for review by the users authorized to view the documents containing the inconsistent information.

The publisher 506 also sets permissions on which of the users may view each document and sets permissions on which users may electronically sign (i.e., execute) each of the documents. In one embodiment, the publisher 506 validates setting the authorized viewers and signers. The workflow manager 512 provides the publisher 506 with information regarding the viewing and signing authorizations and may perform some or all of the verification functionality.

Next, the publisher 506 publishes the transaction documents by making the transaction documents available to the authorized users and the transaction documents enter the published state 406. Hence, an authorized user, such as a borrower 106 (FIG. 1), may access a published transaction document for which the user is an authorized viewer via the web servers 122 (FIG. 1). The user may then view the documents, print out the documents, or both. The publisher 506 may alternatively, or additionally, route the published documents to authorized users by email, by facsimile transmission, or by other suitable means.

Next, the system 500 permits the electronic signing, or electronic execution, of the published documents via a signing step. In one embodiment, the electronic signing of the published documents occurs after each of the participants has approved the published documents to which they have authorized access. The publisher 506 and the signature engine 514 enable the electronic signing of the published documents. Optionally, the signature engine 514 may comprise a separate application.

The publisher 506 manages the electronic signing of each of the published documents. In particular, for each of the published documents to be electronically signed, the publisher 506 opens the published document, identifies which of the participants is to sign the published document, and presents the published document to the participant or participants who are to sign the published document. The signing participant or participants then electronically sign the document using the signing engine 514.

There are two general categories of electronic signatures, those that represent a signature line on a document and those that act as a tamper seal to an electronic document. The signing engine 514 may permit electronic signing a signature that represents a signature line on a document of the published document by using one or more conventional signing electronic signature technologies. For example, the signing engine 514 may permit electronic signing by using techniques such as affixing a holograph, click signing, entry of a PIN (Personal Identification Number), entry of a password, use of an electronic signature pad, use of electronic ink, or the like. Thus, this type of electronic signature may comprise text, an image of a handwritten signature, or software code that represents the signature.

In some applications, to address certain regional requirements, a lawyer, a notary, or both may be required to attend and participate in the electronic signing of the published documents. These parties may also be required to electronically sign certain ones of the published documents. Nonetheless, the electronic signing may be performed at any suitable computer system, such as a personal computer, in communication with the financial services system 110 (FIG. 1).

Once an electronic signature is affixed to a given document, the signing engine 514 tamper seals the document to make the document tamper-proof. In one embodiment, the signing engine 514 tamper seals the document using public key encryption techniques by encrypting the signed document.

The signing engine 514 may also employ use of digital certificates to tamper seal the documents and may employ an associated object (not shown) to manage the digital certificates and to provide digital certificate-based authentication.

Accordingly, the signing engine 514 outputs a signed, tamper-sealed document and the document enters the signed state 408 (FIG. 4). The publisher 506 and the signing engine 514 may then repeat this process for each of the published documents that are to be signed by one or more of the participants. This process may continue until each of the published documents is converted into a signed, tamper-sealed document. The documents then enter the signed state 408.

The delivery engine 516 generally registers the transaction associated with the signed, tamper-sealed documents, creates a delivery package, and controls transfers of rights under the transaction. For example, in the context of a home mortgage transaction, the delivery engine controls transfers of ownership of the note underlying the home mortgage loan.

In operation, the delivery engine 516 receives the signed, tamper-sealed documents, including one or more documents evidencing the rights of the lender in the underlying transaction (e.g., the note) from the signing engine 514. The delivery engine 516 then stores in a registry (not shown) a list of the signed, tamper-sealed documents associated with the transaction. The registry may be stored in the one or more database servers 126 (FIG. 1) and comprises a list, associated with the transaction, of each of the signed, tamper-sealed documents associated with the transaction. The registry also includes storage information indicating the storage location of each of the signed, tamper-sealed documents. Hence, authorized users may view the registry associated with a particular transaction to obtain a list of the documents associated with the transaction and to obtain storage location information for each of the documents. Embodiments of this process, registry, and physical storage of the negotiable instruments may comply with the requirements of Section 16 of the UETA (“Uniform Electronic Standards Act”) in addition to authoritatively determining the ownership of such instruments listed in the registry.

The delivery engine 516 also creates a loan delivery package of documents associated with a particular transaction. The delivery package may comprise an electronic copy of each of the signed, tamper-sealed documents. The delivery engine 516 stores the delivery package in a secure location, which may be referred to as an electronic vault. In one embodiment, the electronic vault is implemented within the one or more database servers 126 (FIG. 1). The electronic vault is the physical storage location of the signed, tamper-sealed documents for later access by one or more authorized users.

The delivery engine 516 may also perform electronic recording of certain transaction documents, such as a deed, with government or other recording entities. In one embodiment, the delivery engine 516 transmits an electronic copy of certain predetermined transaction documents to a government entity, such as a county recorder for recordation purposes. The delivery engine 516 may also coordinate storage of any receipt information received from the recording entity.

The delivery engine 516 also tracks ownership of the documents evidencing the rights of the lender in the underlying transaction by maintaining a record of transfer associated with the documents evidencing the rights of the lender in the underlying transaction. In one embodiment, these documents include a note.

In some home mortgage loan transactions the lender may choose to sell, assign, or otherwise transfer ownership in the note underlying a home mortgage loan transaction to a third party investor. Fannie Mae of Washington D.C., is one example of such a third party investor.

To facilitate such transfer of ownership, the delivery engine 516 maintains a record of transfer (not shown) associated with each transaction. This record of transfer may be securely stored in the electronic vault described above or in another suitable secure location. Initially, the lender is listed as the owner of the documents evidencing the rights of the lender in the underlying transaction and is thus listed as a first entry in the record of transfer. The loan package is then made accessible to the lender by one or more mechanisms, including access via the web servers 112 (FIG. 1).

Subsequently, when the documents evidencing the rights of the lender in the underlying transaction are sold, assigned, or otherwise transferred to another party, such as a third party investor, the delivery engine 516 adds an entry in the record of transfer showing the receiving party as the new owner. The system 500 also then designates the new owner as an authorized entity for accessing the loan delivery package and the associated registry for the association transaction. Thus, the delivery engine 516 permits paperless recording of transfers of ownership of the documents evidencing the rights of the lender in the underlying transaction.

Similarly, the delivery engine 516 also records subsequent transfers of ownership of documents, including notes. For each subsequent transferee of ownership of the documents, the subsequent transferee is listed in the record of transfer and is given access to the loan delivery package.

Lastly, the loan delivery package may be delivered to the new investor by a variety of mechanisms, including access via the web servers 112 (FIG. 1).

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

What is claimed is:

1. A method for facilitating a financial transaction, the method comprising:
providing a common digital platform accessible to a plurality of users;
providing at the common digital platform a set of electronic documents, each electronic document comprising a data index and a set of data fields associated with the document;
receiving transaction information at the digital platform;
merging the received transaction information in the data index associated with each document;
populating the data fields of the document with the information from the data index of each document;
determining whether corresponding data fields in different documents contain identical information.

2. The method of claim 1, further comprising:
receiving updated transaction information at the digital platform;
merging the received updated transaction information in the data index associated with each document;
replacing previously received transaction information with the updated transaction information.

3. The method of claim 1, wherein the documents comprise XML or HTML documents.

4. The method of claim 1, further comprising determining whether the transaction information complies with a predetermined set of rules.

5. The method of claim 1, further comprising maintaining the documents in a predetermined order.

6. The method of claim 1, further comprising determining whether corresponding information in the data index of a single document is identical.

7. The method of claim 1, further comprising presenting a user with a message if the corresponding information in the data indexes of different documents is not identical.

8. The method of claim 1, further comprising:
publishing the documents;
permitting editing of the documents;
permitting viewing of the document only after successful syntactic and semantic validation.

9. The method of claim 1, further comprising:
tamper-sealing at least one of the documents;
determining whether the tamper-sealed document has been edited subsequent to the tamper-sealing;
presenting a user with a message if the tamper-sealed document has been edited subsequent to the tamper-sealing.

10. The method of claim 1, further comprising determining whether the information in the data index of each document is identical to corresponding data in the transaction information.

11. The method of claim 1, further comprising designating a set of transaction participants that are authorized to access the documents.

12. The method of claim 1, further comprising:
designating a first set of transaction participants that are authorized to access a first set of the documents;
designating a second set of transaction participants that are authorized to access a second set of the documents, wherein the first and second sets of transaction participants are not mutually exclusive.

13. The method of claim 1, further comprising designating at least one transaction participant authorized to sign individual transaction documents.

14. The method of claim 1, further comprising permitting electronic signature of the documents.

15. The method of claim 1, further comprising:
permitting electronic signature of individual documents;
encrypting at least one of the documents after individual documents have been electronically signed.

16. The method of claim 1, further comprising maintaining a record of transfer associated with the documents.

17. The method of claim 1, further comprising maintaining a record of transfer associated with the documents, wherein a lender is listed as a first entry in the record of transfer and a subsequent transferee is listed as a second entry in the record of transfer.

18. The method of claim 1, further comprising maintaining a registry of the documents, the registry comprising identification information and storage location information for each of the documents.

19. The method of claim 1, further comprising:
permitting individual ones of the documents to be electronically signed;
encrypting at least one of the electronically signed documents;
storing the encrypted documents in an electronic vault;
maintaining a record of transfer associated with the encrypted documents.

20. The method of claim 1, further comprising transmitting transaction information to a government recorder for recordation at the government recorder.

21. The method of claim 1, further comprising determining a type of the financial transaction and selecting the set of electronic documents that corresponds to the type of the financial transaction.

22. A method for determining an estimate of closing costs associated with a real estate transaction, the method comprising:
providing a database including a cost estimate for each of a plurality of separate types of closing costs for each of a plurality of geographical locations;
receiving transaction information, the transaction information including identification of the geographical location of the real estate;
identifying a set of separate closing costs from the database based on the transaction information;
determining an estimate of closing costs associated with the real estate transaction based on the identified set of separate closing costs.

23. The method of claim 22, wherein the transaction information further comprises an address of the real estate.

24. The method of claim 22, wherein the transaction information further comprises an approximate value of the real estate.

25. The method of claim 22, wherein the transaction information further comprises a loan amount.

26. The method of claim 22, wherein the plurality of separate closing costs further comprises: an appraiser fee, an inspection fee, and a title fee.

27. The method of claim 22, wherein the separate closing costs further comprises: tax costs and insurance costs.

28. The method of claim 22, wherein the determining an estimate of closing costs associated with the real estate transaction further comprises summing the identified set of separate costs.

29. The method of claim 22, wherein the separate types of closing costs further comprise real estate commission costs.

30. The method of claim 22 wherein the transaction information further includes a down payment amount.

31. The method of claim 22 wherein the separate types of closing costs further comprise a real estate commission cost, a processing fee, a tax fee, an appraiser fee, and an inspection fee.

32. A method of automating a real estate mortgage transaction, the method comprising:
generating a set of real estate mortgage transaction documents in electronic format, the real estate mortgage transaction documents including a note;
permitting electronic execution of the note;
encrypting the executed note;
storing the encrypted note in an electronic vault.

33. The method of claim 32, further comprising:
associating a record of transfer with the encrypted note;
listing lender identification information as an entry on the record of transfer.

34. The method of claim 33, wherein the record of transfer is stored in the electronic vault.

35. The method of claim 32, further comprising:
associating a record of transfer with the encrypted note;
listing lender identification information as an entry on the record of transfer;
receiving information identifying a transfer to a first investor;
listing first investor information as an entry on the record of transfer.

36. The method of claim 35, further comprising:
receiving information identifying a transfer to a second investor;
listing the second investor as an entry on the record of transfer.

37. The method of claim 32, further comprising maintaining a registry associated with the real estate mortgage transaction documents, the registry comprising an identifier and storage location information for each of the real estate mortgage transaction documents.

38. The method of claim 32, further comprising only permitting access to the encrypted note by a current owner of the note.

39. A method for managing funds in a financial transaction, the method comprising:
determining an amount of funds to be paid into the financial transaction;
determining an amount of funds to be paid out of the financial transaction;
determining whether the amount of funds to be paid into the financial transaction equals the amount of funds being paid out of the financial transaction;
determining whether the funds to be paid into the financial transaction have been received;
coordinating disbursement of the funds to be paid out of the financial transaction only if the amount of funds to be paid into the financial transaction equals the amount of funds being paid out of the financial transaction and the funds to be paid into the financial transaction have been received.

40. The method of claim 39, wherein the coordinating disbursement of the funds further comprises sending a wire transfer of funds to a payee.

41. The method of claim 39, wherein the coordinating disbursement of the funds further comprises sending an ACH disbursement to a payee.

42. The method of claim 39, wherein the coordinating disbursement of the funds further comprises printing a check made out to a payee.

43. The method of claim 39, wherein the coordinating disbursement of the funds further comprises sending a disbursement to each of multiple payees.

44. The method of claim 39, wherein the coordinating disbursement of the funds further comprises sending a disbursement to each of multiple payees, the payees including a title company and a closing agent.

45. The method of claim 39, further comprising preventing disbursements associated with the financial transaction if the amount of funds to be paid into the financial transaction does not equal the amount of funds being paid out of the financial transaction or if the funds to be paid into the financial transaction have not been received.

46. The method of claim 39, further comprising generating a user message regarding the funds associated with the financial transaction if the amount of funds to be paid into the financial transaction does not equal the amount of funds being paid out of the financial transaction.

47. A system for providing financial services automation of transactions, the system comprising:
a documents management module for managing a set of transaction documents;
a funds management module for managing transfers of funds between entities associated with the transaction;
a signature module for permitting electronic execution of at least one of the transaction documents;
a delivery module for recording changes in ownership of at least one of the transaction documents.

48. The system of claim 47, further comprising a dynamic pricing engine for generating a closing cost estimate based on a geographical location of a real estate property.

49. The system of claim 47, further comprising an analytic services engine for generating statistics based on the transactions.

50. The system of claim 47, further comprising a tracking module for monitoring advancement of a transaction and identifying occurrence of certain transaction events and notifying transaction participants of the occurrence of the transaction events.

51. The system of claim 47, further comprising a recording module for electronically transmitting transaction information to a government recorder for recordation at the government recorder.

52. The system of claim 47, further comprising a payment module for executing transfer of funds based on data from the funds management module.

53. The system of claim 47, further comprising a process automation module for coordinating the functions of the documents management module, the funds management module, the signature module, and the delivery module.

54. A system for managing transaction documents, the system comprising:
a common digital platform accessible to a plurality of users;
a set of electronic documents stored at the common digital platform, each electronic document comprising a data index and a set of data fields associated with the document;
the common digital platform being configured to receive transaction information in electronic format and to merge the received transaction information in the data index associated with each document;
wherein the common digital platform is configured to populate the data fields of the document with the information from the data index of each document and to determine whether corresponding data fields in different ones of the documents contain identical information.

55. The system of claim 54, wherein the common digital platform is configured to receive updated transaction information and to replace corresponding transaction information with the updated transaction information.

56. The system of claim 54, wherein the documents comprise XML or HTML documents.

57. The system of claim 54, wherein the common digital platform is configured to permit viewing by a user of at least one of the documents.

58. The system of claim 54, wherein the common digital platform determines whether corresponding information in the data indexes of different documents is not identical.

59. The system of claim 54, wherein the common digital platform is configured to tamper-seal one or more of the documents.

60. The system of claim 54, wherein the common digital platform is configured to designate a first set of transaction participants that are authorized to view a first set of the documents and a second set of transaction participants that are not authorized to view the first set of transaction documents.

61. The system of claim 54, wherein the common digital platform is configured to permit electronic signature of individual ones of the documents.

62. A system for determining an estimate of closing costs associated with a real estate transaction, the system comprising:
a database including a cost estimate for each of a plurality of separate types of closing costs for each of a plurality of geographical locations;
a computer system coupled to a network for receiving transaction information over the network, the transaction information including identification of the geographical location of the real estate;
the computer system configured to identify a set of separate closing costs from the database based on the transaction information and to determine an estimate of closing costs associated with the real estate transaction based on the identified set of separate closing costs.

63. The system according to claim 62, wherein the transaction information includes a mailing address associated with the real estate.

64. The system according to claim 62, wherein the plurality of separate closing costs further comprises a tax cost, an insurance cost, a title fee, an appraiser fee, and an inspection fee.

65. The system according to claim 62, wherein the transaction information further comprises a down payment amount.

66. A system for automating a real estate mortgage transaction, the system comprising:
a computer-readable medium having a set of real estate mortgage transaction documents stored thereon, the real estate mortgage transaction documents including a note;
a computer system including an electronic signature module for permitting electronic signature of the note by a user, the electronic signature module being configured to encrypt the note after being electronically signed;
a storage device for storing the encrypted note in an electronic vault.

67. The system according to claim 66, wherein a record of transfer is stored at the storage device, the record of transfer being associated with the encrypted note and listing lender identification information as an entry on the record of transfer.

68. The system according to claim 67, wherein an investor is listed as an entry on the record of transfer.

69. The system according to claim 66, wherein a registry is stored at the storage device, the registry comprising an identifier and storage location information for each of the real estate mortgage transaction documents.

70. The system according to claim 66, wherein the computer system is configured to only permit access to the encrypted note by a current owner of the note.

71. A system for performing funds management for a financial transaction, the system comprising:
a computer system having a funds management module for determining an amount of funds to be paid into the financial transaction and an amount of funds to be paid out of the financial transaction;
the funds management module configured to determine whether the amount of funds to be paid into the financial transaction equals the amount of funds to be paid out of the financial transaction and to only permit disbursement of the funds to be paid out of the financial transaction if the funds to be paid into the financial transaction have been received and are equal in amount to the amount of funds to be paid out of the financial transaction.

72. The system according to claim 71, wherein the funds management module is configured to coordinate disbursement of funds to one or more payees.

73. The system according to claim 71, wherein the funds management module is configured to prevent disbursements associated with the financial transaction if the amount of funds to be paid into the financial transaction does not equal the amount of funds being paid out of the financial transaction or if the funds to be paid into the financial transaction have not been received.

74. The system according to claim 71, wherein the funds management module is configured to coordinate disbursement of funds by a wire transfer or by a ACH disbursement.

75. A system for performing analytic techniques to mortgage transaction information, the system comprising:
a storage device having mortgage transaction information stored thereon, the mortgage transaction information comprising information associated with multiple transactions, multiple lenders, real estate properties located in different geographical locations;
a computer system including an analytic services module for performing statistical analysis of the mortgage transaction information.

76. The system according to claim 75, wherein the analytic services module is configured to determine a number of mortgage transactions closed by a particular one of the lenders in a given time period.

77. The system according to claim 75, wherein the analytic services module is configured to determine a percentage of mortgage transactions closed in a particular geographical area in given time by a particular one of the lenders.

78. The system according to claim 75, wherein the analytic services module is configured to determine an average amount of time taken for each of a subset of the mortgage transactions to close.
